(19) United States
(12) Patent Application Publication
(10) Pub. No.: US 2018/0184189 A1
(43) Pub. Date: Jun. 28, 2018

(54) Load sharing for charging peripheral device

(71) Applicant: BRAGI GmbH, München (DE)

(72) Inventor: Peter Vincent Boesen, München (DE)

(73) Assignee: BRAGI GmbH, München (DE)

(21) Appl. No.: 15/852,011

(22) Filed: Dec. 22, 2017

Related U.S. Application Data
(60) Provisional application No. 62/439,397, filed on Dec. 27, 2016.

(51) Int. Cl. H04R 1/10; H02J 7/00

(52) U.S. Cl. CPC H04R 1/1025; H04R 1/1016; H04R 2420/07; H02J 7/0021; H04R 1/1041

(57) ABSTRACT

Embodiments for a method of providing battery life to a battery of a peripheral device using an earpiece worn by a user may include one or more of the following steps: (a) receiving a first signal from the peripheral device, wherein the signal encodes a request for additional power, (b) providing the additional power to the peripheral device in response to the first signal, (c) transmitting a second signal to the peripheral device in response to the first signal, wherein the second signal encodes a request for an additional amount of power to provide, (d) receiving a third signal from the peripheral device in response to the second signal, wherein the third signal encodes the amount of additional power to provide, and (e) receiving a signal from the peripheral device encoding a power termination request.

### PRIORITY STATEMENT

This application claims priority to U.S. Provisional Patent Application No. 62/439,397, filed Dec. 27, 2016, titled Load Sharing for Charging Peripheral Device, hereby incorporated by reference in its entirety.

### FIELD OF THE INVENTION

The present invention relates to wearable devices. Particularly, the present invention relates to earpieces and wearable devices. More particularly, but not exclusively, the present invention relates to load sharing between earpieces and a peripheral wearable device.

### BACKGROUND

Power management is a critical aspect of all battery reliant devices. The user expects such devices to provide highly accurate and instantaneous responses from the device for the feature being utilized. However, such responsiveness comes at the price of increased power drain on the available resources. Such power demands limits device functionality by creating a rate limiting effect induced through power drain. What is needed is a system and method designed to maintain high quality function of the features of the device while preserving power.

Batteries currently used in wireless devices tend to require frequent recharging when in use. This can be problematic when the wireless device needs to perform computationally intensive tasks with low battery life, as it cannot always be anticipated when the wireless device will need to perform a computationally intensive task. However, if a user is using more than one wireless device, one of the wireless devices may need additional energy which another wireless device carries. What is thus needed is a method and system of load sharing between two or more wearable devices to maximize the useful life of a wearable device with a low battery level.

### SUMMARY

Therefore, it is a primary object, feature, or advantage of the present invention to improve over the state of the art.

Embodiments for a method of managing battery life for a peripheral device battery may include one or more of the following steps: (a) monitoring the battery life of the battery using a battery sensor operably coupled to the peripheral device, (b) communicating a signal to an earpiece worn by a user if the battery life of the battery falls below a critical threshold, wherein the signal encodes a request to provide additional power to the peripheral device, and (c) receiving the additional power from the earpiece worn by the user.

Embodiments for a method of providing battery life to a battery of a peripheral device using an earpiece worn by a user may include one or more of the following steps: (a) receiving a first signal from the peripheral device, wherein the signal encodes a request for additional power, (b) providing the additional power to the peripheral device in response to the first signal, (c) transmitting a second signal to the peripheral device in response to the first signal, wherein the second signal encodes a request for an additional amount of power to provide, (d) receiving a third signal from the peripheral device in response to the second signal, wherein the third signal encodes the amount of additional power to provide, and (e) receiving a signal from the peripheral device encoding a power termination request.

Embodiments for a system may have one or more of the following features: (a) a set of earpieces, wherein each earpiece may have one or more of the following features: (1) an earpiece housing, (2) a transceiver disposed within the earpiece housing, (3) a processor disposed within the earpiece housing and operably coupled to the transceiver, (4) a battery disposed within the earpiece housing and operably coupled to the transceiver and the processor, and (5) an interface operably coupled to the earpiece housing and the battery, (b) a peripheral device operably coupled to the set of earpieces, the peripheral device may have one or more of the following features: (1) at least one peripheral interface, (2) a peripheral device transceiver disposed within the peripheral device, (3) a peripheral device processor operably coupled to each peripheral interface and the peripheral transceiver, and (4) a peripheral device battery operably coupled to each peripheral interface, the peripheral device transceiver and the peripheral device processor, wherein each earpiece of the set of earpieces is configured to provide additional power to the peripheral device via the interfaces in response to a signal from the peripheral device encoding a request for the additional power.

One or more of these and/or other objects, features, or advantages of the present invention will become apparent from the specification and claims follow. No single embodiment need provide every object, feature, or advantage. Different embodiments may have different objects, features, or advantages. Therefore, the present invention is not to be limited to or by an object, feature, or advantage stated herein.

### BRIEF DESCRIPTION OF THE DRAWINGS

Illustrated embodiments of the disclosure are described in detail below with reference to the attached drawing figures, which are incorporated by reference herein.

FIG. 1 illustrates a flowchart of a method of managing battery life of a battery of a peripheral device in accordance with an embodiment of the present invention;

FIG. 2 illustrates a flowchart of a method of providing battery life to a battery of a peripheral device using an earpiece in accordance with an embodiment of the present invention;

FIG. 3 illustrates a flowchart of a method of providing battery life to a battery of a peripheral device using an earpiece in accordance with an embodiment of the present invention;

FIG. 4 illustrates a block diagram of a system including a set of wireless earpieces and the peripheral device in accordance with an embodiment of the present invention;

FIG. 5 illustrates a block diagram of a system including a set of wireless earpieces and the peripheral device in accordance with an embodiment of the present invention;

FIG. 6 illustrates a pictorial relationship of the set of wireless earpieces and a peripheral device and the relationship between the set of wireless earpieces and the peripheral device when transferring power in accordance with an embodiment of the present invention; and

FIG. 7 illustrates a relationship between the set of wireless earpieces, the peripheral device, and a mobile device in accordance with an embodiment of the present invention.

Various of the figures include ornamental appearance for various elements. It is to be understood the present invention contemplates all permutations and combinations of the various graphical elements set forth in the screen displays and any portions thereof.

### DETAILED DESCRIPTION

The following discussion is presented to enable a person skilled in the art to make and use the present teachings. Various modifications to the illustrated embodiments will be clear to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of earpieces and wearable electronics with load-sharing functionality, it is fully contemplated embodiments of the present invention could be used in most any electronic communications device without departing from the spirit of the invention.

It is an object, feature, or advantage of the present invention to maximize the useful battery life of a wearable device.

It is a still further object, feature, or advantage of the present invention to maximize the useful battery life of a wearable device using the battery life of another wearable device.

Another object, feature, or advantage is to maximize the useful battery life of a peripheral wearable device using one or more wireless earpieces.

Yet another object, feature, or advantage is to maximize the useful battery life of an eyepiece using one or more wireless earpieces via galvanic transmission.

Yet another object, feature, or advantage is to maximize the useful battery life of a virtual reality device using one or more wireless earpieces via galvanic transmission.

Yet another object, feature, or advantage is to maximize the useful battery life of a digital recording device using one or more wireless earpieces via galvanic transmission.

Yet another object, feature, or advantage is to provide continuous power to a peripheral device if requested.

Yet another object, feature, or advantage is to allow a wireless earpiece to transmit a request for power to provide if the original request by the peripheral device failed to stipulate the exact amount.

In one embodiment, a method of managing battery life of a battery of a peripheral device includes monitoring the battery life of the battery using a battery sensor operably coupled to the peripheral device, communicating a signal to an earpiece worn by a user if the battery life of the battery falls below a critical threshold, wherein the signal encodes a request to provide additional power to the peripheral device, and receiving the additional power from the earpiece worn by the user.

One or more of the following features may be included. The peripheral device may be an eyepiece. The peripheral device may be a virtual reality device. The peripheral device may be a digital recording device. The signal from the peripheral device may further encode an amount of power to provide to the peripheral device. The additional power may be received galvanically from the user.

In another embodiment, a method of providing battery life to a battery of a peripheral device using an earpiece worn by a user includes receiving a first signal from the peripheral device, wherein the signal encodes a request for additional power and providing the additional power to the peripheral device in response to the first signal.

One or more of the following features may be included. The peripheral device may be an eyepiece, a virtual reality device, or a digital recording device. The additional power may be provided galvanically through a user. The reception of the first signal from the peripheral device may be at a transceiver of a left earpiece. The reception of the first signal from the peripheral device may be at a transceiver of a right earpiece. A second signal may be transmitted to the peripheral device in response to the first signal, wherein the second signal encodes a request for an additional amount of power to provide. A third signal may be received from the peripheral device in response to the second signal, wherein the third signal encodes the amount of additional power to provide. The provision of the additional power may be provided continuously. A signal may be received from the peripheral device encoding a power termination request.

In another embodiment, a system includes a set of earpieces. Each earpiece includes an earpiece housing, a transceiver disposed within the earpiece housing, a processor disposed within the earpiece housing and operably coupled to the transceiver, a battery disposed within the earpiece housing and operably coupled to the transceiver and the processor, and an interface operably coupled to the earpiece housing and the battery. A peripheral device is operably coupled to the set of earpieces. The peripheral device includes at least one peripheral interface, a peripheral device transceiver disposed within the peripheral device, a peripheral device processor operably coupled to each peripheral interface and the peripheral transceiver, and a peripheral device battery operably coupled to each peripheral interface, the peripheral device transceiver, and the peripheral device processor. Each earpiece of the set of earpieces is configured to provide additional power to the peripheral device via the interfaces in response to a signal from the peripheral device encoding a request for the additional power.

One or more of the following features may be included. The peripheral device may be an eyepiece, a virtual reality device, or a digital recording device. Each interface of the set of wireless earpieces and each peripheral interface of the peripheral device may be positioned along a surface of a user's ear. The additional power may be provided to the peripheral device battery via at least one interface of the set of wireless earpieces and at least one peripheral interface of the peripheral device. The signal may encode an amount of additional power to provide to the peripheral device battery.

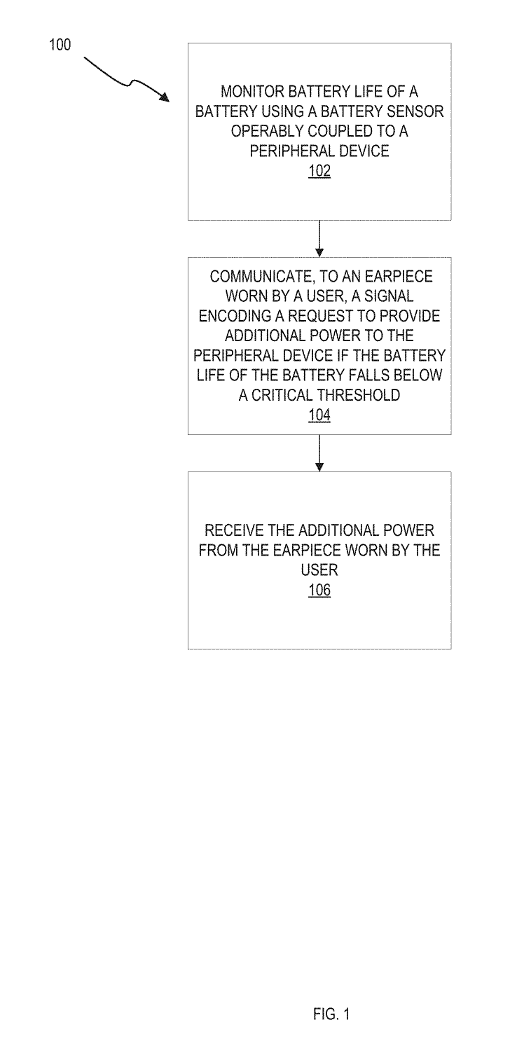

FIG. 1 illustrates a method of managing the battery life of a peripheral device battery 100. The peripheral device may be an electronic eyepiece wearable by a user (e.g. Google Glass, Snapchat Spectacles), a virtual reality device (e.g. Oculus Rift, PlayStation VR, HTC Vive), a digital recording device, or another type of electronic wearable device. First, in step 102, a battery sensor coupled to the battery of the peripheral device monitors the battery life of the battery.

The battery sensor may employ various methods for determining the battery life of the battery, including coulomb counting, voltage estimation, impedance spectroscopy, or other known methods of battery life or state of charge estimations. For example, the battery sensor may measure a voltage across a current shunt with a known resistance or impedance, which may be used by one or more programs, applications, or algorithms stored within a memory or a processor to estimate the current at one or more specific points in time. The current estimations may then be subsequently integrated with respect to time using the same or a different program, application, or algorithm to estimate the amount of charge the battery has discharged. The battery life may then be estimated by subtracting the estimated amount of charge discharged by the battery from an initial charge state via one or more programs, applications, or algorithms executed by a processor. The initial charge state of the battery may be estimated by comparing a voltage measured across the battery at a known temperature with a discharge profile of a similar battery with respect to capacity at the same temperature. Additional physical parameters may be used by one or more programs, applications, or algorithms executed by a processor to determine the battery life of the battery. These additional physical parameters may include the battery's usable capacity, charge and discharge rates, age, life cycle, hysteresis profile, or chemical composition, the physical layout of the circuitry coupled to the battery, the ambient temperature, or other parameters pertinent to estimating a battery life of a battery.

In step 104, the peripheral device communicates a signal to an earpiece worn by a user encoding a request to provide additional power to the peripheral device if the battery life of the battery of the peripheral device falls below a critical threshold. The peripheral device may communicate the signal using a transceiver or may communicate the signal galvanically through the user's skin to an earpiece. The signal may encode additional information, such as the amount of power (charge) to transfer to the peripheral device, when to transfer the power, the charge currently remaining on the battery of the peripheral device, programs or applications currently running or scheduled to be run by the peripheral device or other information potentially pertinent to obtaining power from an earpiece. The critical threshold may be a threshold preprogrammed within the peripheral device or a program or application specific threshold.

In step 106, the peripheral device receives the additional power from the earpiece worn by the user. The power may be provided galvanically through the skin of the user to the peripheral device. One or more electronic interfaces may be configured for receiving the additional power. Alternatively, the earpiece worn by the user may be in direct contact with the peripheral device and may simply transfer the amount of additional power requested by the peripheral device. The additional power may be provided continuously or intermittently as required.

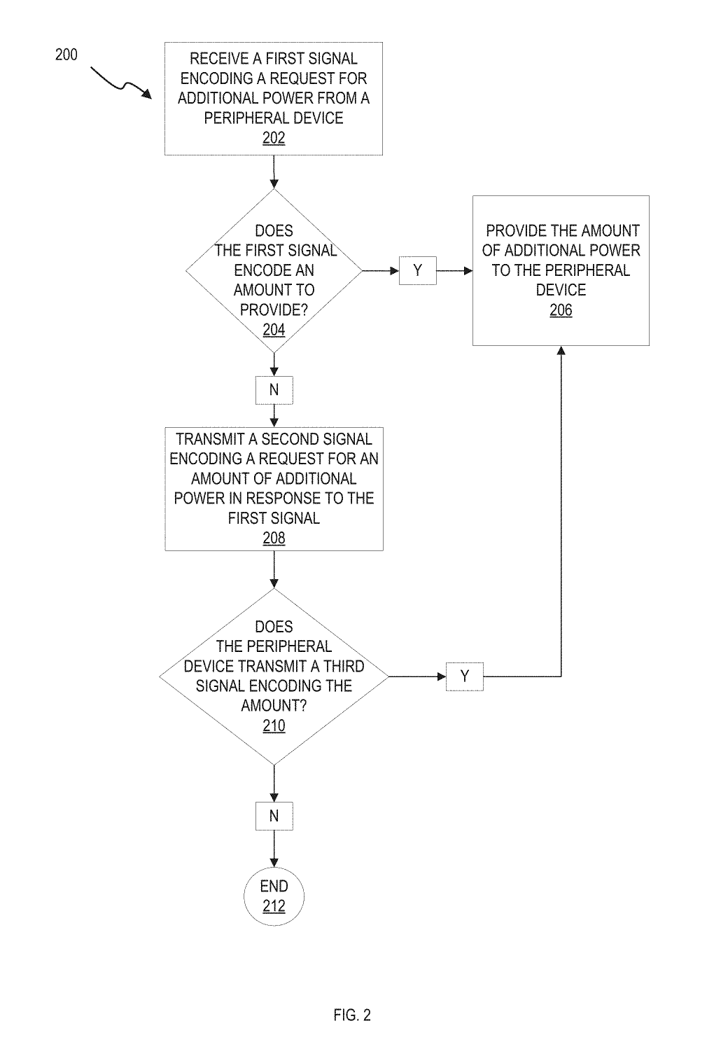

FIG. 2 illustrates a method of providing battery life to a battery of a peripheral device using an earpiece worn by a user 200. Like in FIG. 1 above, the peripheral device may be an electronic eyepiece wearable by a user (e.g. Google Glass, Snapchat Spectacles), a virtual reality device (e.g. Oculus Rift, PlayStation VR, HTC Vive), a digital recording device, or another type of electronic wearable device. First, in step 202, an earpiece worn by the user receives a first signal from a peripheral device encoding a request for additional power. The first signal may be received by a left earpiece worn by the user, a right earpiece worn by the user, or both earpieces, and the first signal may request power from more than one earpiece. The first signal may be received at an earpiece via a transceiver or antenna operably coupled to the earpiece or galvanically through the user's skin. Alternatively, if the peripheral device is in physical contact with one or more earpieces worn by the user, the signal may be received directly from the peripheral device.

If the information encoded in the first signal transmitted by the peripheral device contains an amount of additional power to provide in step 204, then in step 206, one or more earpieces worn by the user provides the additional power to the peripheral device. The additional power may be provided continuously, intermittently or at specific intervals desired by the peripheral device or one or more of the earpieces worn by the user. In addition, the additional power may be provided galvanically through the user's skin to the peripheral device. Depending on the amount of charge (power) available in each earpiece, if the peripheral device requests power from more than one earpiece, then one earpiece may provide, for example, only 20% of the power while the other earpiece provides the other 80% required. In addition, one earpiece may finish delivering power before the other earpiece, and may finish before the other earpiece commences delivery of power depending on the programs or applications running on each earpiece.

If the first signal did not encode a specific amount to provide to the peripheral device in step 204, then in step 208, an earpiece worn by the user transmits a second signal encoding a request for an amount of additional power to provide to the peripheral device. The second signal may encode additional information such as how to deliver the additional power, where to deliver the additional power, the amount of charge available on the earpiece, which can provide power, or other information pertinent to providing additional power to the peripheral device. If the peripheral device transmits a third signal with the amount of power to deliver to the peripheral device in step 210, then each earpiece receiving the first signal delivers the amount in accordance with step 206. The percentage delivered by each earpiece, if the request is for more than one earpiece to deliver power, may be determined in accordance with one or more programs or applications of one or more of the earpieces. If the peripheral device fails to transmit a third signal with the amount of power to provide, none of the earpieces worn by the user provide any power, and the process ceases in step 212.

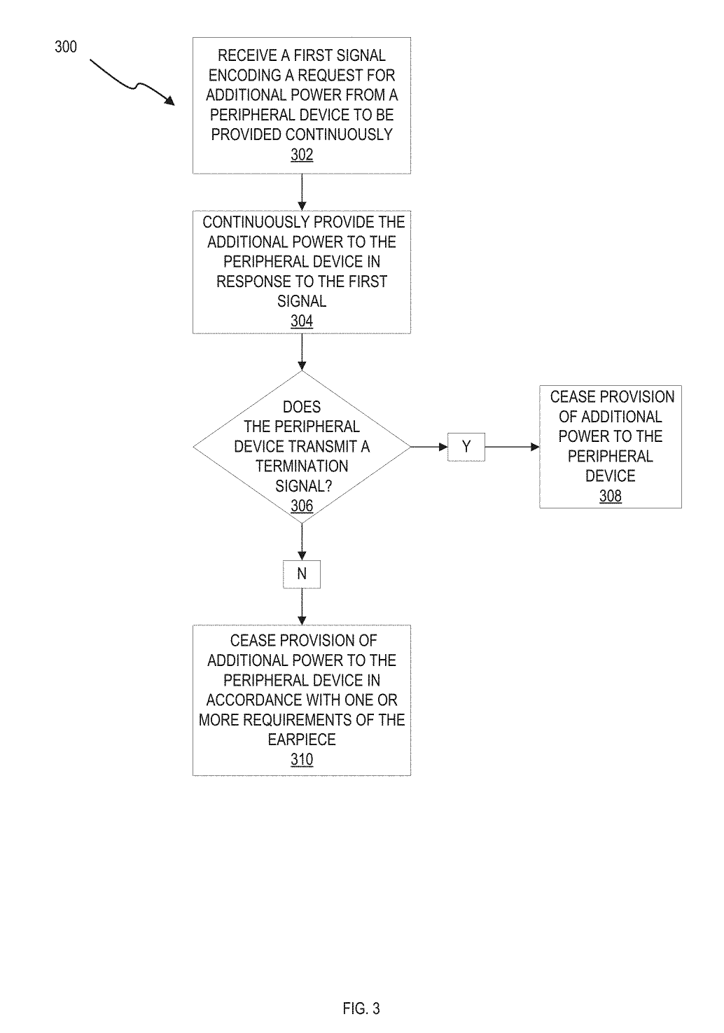

FIG. 3 illustrates a second embodiment a method of providing battery life to a battery of a peripheral device using an earpiece worn by a user 300. Like in FIG. 1 and FIG. 2 above, the peripheral device may be an electronic eyepiece wearable by a user (e.g. Google Glass, Snapchat Spectacles), a virtual reality device (e.g. Oculus Rift, PlayStation VR, HTC Vive), a digital recording device, or another type of electronic wearable device. First, in step 302, an earpiece worn by the user receives a first signal from a peripheral device encoding a request for additional power, wherein the request is for the additional power to be delivered continuously. Like step 202, the first signal may be received by a left earpiece worn by the user, a right earpiece worn by the user, or both earpieces, and the first signal may request power from more than one earpiece. The first signal may be received at an earpiece via a transceiver or antenna operably coupled to an earpiece or galvanically through the user's skin. Alternatively, if the peripheral device is in physical contact with one or more earpieces worn by the user, the signal may be received directly from the peripheral device.

In step 304, one or more earpieces worn by the user provides additional power to the peripheral device. The additional power may be provided galvanically through the user's skin to the peripheral device. Depending on the amount of charge (power) available in each earpiece, if the peripheral device requests power from more than one earpiece, then one earpiece may provide, for example, only 20% of the power while the other earpiece provides the other 80% required. In addition, one earpiece may deliver power to the peripheral device, transfer the task of delivering power to the peripheral device to another earpiece, and potentially transfer the task back to the earpiece originally reassigned the task of providing power to the peripheral device depending on the amount of power contained within each earpiece or in accordance with one or more program or application requirements of one or more of the earpieces.

In step 306, if one or more earpieces worn by the user receives a second signal from the peripheral device to terminate provision of additional power, then in step 308, each earpiece ceases provision of additional power to the peripheral device. If one or more of the earpieces worn by the user does not receive an additional signal, then in step 310, each earpiece ceases provision of additional power in accordance with one or more requirements of each earpiece. Ceasing provision of additional power may be performed in accordance with a critical threshold preprogrammed within the battery or a battery sensor operably coupled to the battery of one or more of the earpieces worn by the user, a critical threshold in accordance with a power management program, application, or algorithm executed by a processor operably coupled to one or more of the earpieces worn by the user, or in accordance with a program, application, or algorithm executed by a processor is unrelated to the power management of one or more of the earpieces worn by the user.

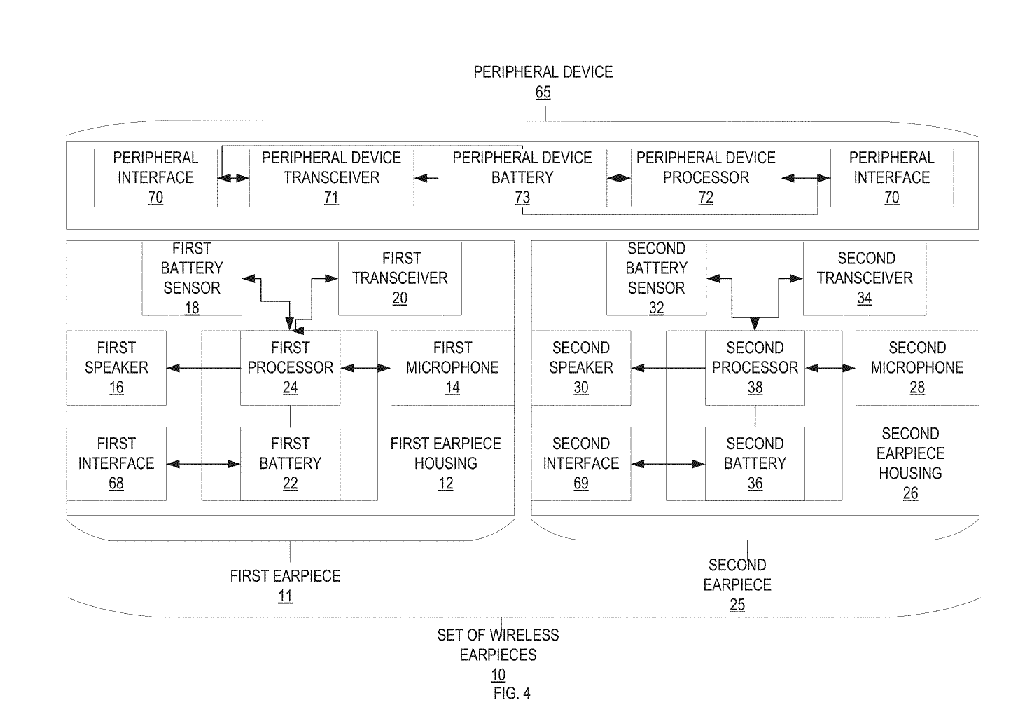

FIG. 4 illustrates a block diagram of a set of wireless earpieces 10 and a peripheral device 65. The set of wireless earpieces 10 includes a first earpiece 11 and a second earpiece 25. The first earpiece 11 may be a left earpiece and the second earpiece 25 may be a right earpiece. The first earpiece 11 includes a first earpiece housing 12, a first microphone 14 operably coupled to the first earpiece housing 12, a first speaker 16 operably coupled to the first earpiece housing 12, a first battery sensor 18 operably coupled to the first earpiece housing 12, a first transceiver 20 operably coupled to the first earpiece housing 12, a first battery 22 disposed within the first earpiece housing 12 and operably coupled to each component of the first earpiece 11, and a first processor 24 disposed within the first earpiece housing 12 and operably coupled to each component of the first earpiece 11.

The second earpiece 25 includes a second earpiece housing 26, a second microphone 28 operably coupled to the second earpiece housing 26, a second speaker 30 operably coupled to the second earpiece housing 26, a second battery sensor 32 operably coupled to the second earpiece housing 26, a second transceiver 34 operably coupled to the second earpiece housing 26, a second battery 36 disposed within the second earpiece housing 26 and operably coupled to each component of the second earpiece 25, and a second processor 38 disposed within the second earpiece housing 26 and operably coupled to each component of the second earpiece 25. The peripheral device 65 includes an interface 70 for receiving additional power from the first earpiece 11 or the second earpiece 25, a transceiver 71 for transmitting signal to or receiving signals from the first earpiece 11 or the second earpiece 25, and a processor 72 disposed within the peripheral device 65.

The first earpiece housing 12 and the second earpiece housing 26 may be composed of plastic, metallic, nonmetallic, or any material or combination of materials having substantial deformation resistance to facilitate energy transfer if a sudden force is applied to the first earpiece 11 or the second earpiece 25. For example, if one of the earpieces is dropped by the user, the earpiece housings may transfer the energy received from the surface impact throughout the entire dropped earpiece. In addition, each earpiece housing may be capable of a degree of flexibility to facilitate energy absorbance if one or more forces is applied to the first earpiece 11 or the second earpiece 25. For example, if an object is dropped on one of the earpieces, the earpiece may bend to absorb the energy from the impact so the components within the earpiece are not substantially damaged. The flexibility of the first earpiece housing 12 and second earpiece housing 26 should not, however, be flexible to the point where one or more components of the first earpiece 11 or the second earpiece 25 become dislodged or otherwise rendered non-functional if one or more forces is applied to one of the earpieces.

First microphone 14 is operably coupled to the first earpiece housing 12 and the second microphone 28 is operably coupled to the second earpiece housing 26. Each microphone may be configured to receive sounds from the environment or receive one or more voice commands from the user. For example, the user may issue a voice command to the first microphone 14 to set the first earpiece 11 to transfer tasks to the second earpiece 25 if the battery level of the first earpiece falls below 50%. The user may also issue a voice command to transfer a task from one earpiece to another earpiece irrespective of any prior user or program setting requirements. Microphones 14 and/or 28, may also be configured to sense one or more sounds. The sounds may originate from the user, a third party, a machine, an animal, wireless earpiece 11 and/or 25, another electronic device 65, or even nature itself. The types of sounds received by the microphones 14 and/or 28 may include words, combinations of words, sounds, combinations of sounds, or any combination of the aforementioned. The sounds may be of any frequency and need not necessarily be audible to the user. Microphones 14 and/or 28 could be most any type of microphone 14 and/or 28 without departing from the spirit of the invention. Microphones 14 and/or 28 could be a large diaphragm condenser, a small diaphragm condenser, a dynamic, a bass, a ribbon, a multi-pattern, a USB or a boundary microphone or any combination of these microphones listed in embodiments of the present invention.

First speaker 16 is operably coupled to the first earpiece housing 12 and the second speaker 30 is operably coupled to the second earpiece housing 26. Each speaker may be configured to communicate a warning to the user if the battery life of the first earpiece or the second earpiece is at a critical level or a critical threshold. For example, if the second earpiece 25 reaches its critical threshold, which may be preset or application-specific, the second processor 38 may instruct the second speaker 30 to communicate “Battery level at critical level. Recommend recharging.” In response to such a warning, the user may issue a voice command to the second microphone 28 to cease running one or more programs or applications currently running on the second earpiece 25, transfer one or more of the programs or applications to the first earpiece 11, or recharge the second earpiece 25.

Speakers 16 and/or 30 can produce audio output. The speakers 16 and/or 30 may also be configured to produce one or more sounds. The sounds may be communicated to a user. The speakers 16 and/or 30 may also produce sounds received from other inputs. For example, the speakers 16 and/or 30 may produce audio signals received from a transceiver 20 and/or 34 along with any sounds the user desires to hear. The sounds could be music stored in memory. Also, the speakers 16 and/or 30 may short out if either an audio signal or an ambient sound is too loud or exceeds a certain decibel threshold, which may be programmable by the user. Speakers 16 and/or 30 could be most any type of speakers 16 and/or 30 without departing from the spirit of the invention. Speakers 16 and/or 30 could be full-range drivers, a subwoofer, a woofer, a mid-range driver, a tweeter, a coaxial driver or a horn loudspeaker or any combination of these speakers listed above. Speakers 16 and/or 30 can have loudspeaker functionality as well.

First battery sensor 18 is operably coupled to the first earpiece housing 12 and second battery sensor 32 is operably coupled to the second earpiece housing 26 and each battery sensor is configured to sense one or more physical parameters used to measure the battery life of a battery. For example, first battery sensor 18 may measure a voltage across a current shunt with a known resistance or impedance, wherein the voltage measurement may be used with one or more programs, applications, or algorithms executed by first processor 24 to estimate the current at one or more specific points in time. The programs, applications, or algorithms used by first processor 24 may be stored in a memory or the first processor 24. The current estimations may then be subsequently integrated with respect to time using the same or a different program, application, or algorithm executed by the first processor 24 to estimate the amount of charge first battery 22 has discharged. The battery life may then be estimated by subtracting the estimated amount of charge discharged by first battery 22 from an initial charge state via one or more programs, applications, or algorithms executed by the first processor 24. The initial charge state of first battery 22 may be estimated by comparing a discharge voltage measured across first battery 22 at a known temperature with a discharge profile of a similar battery with respect to capacity at the same temperature.

The second battery sensor 32 may estimate the battery life of the second battery 36 in a similar manner as described above. Additional physical parameters may also be used by one or more programs, applications, or algorithms to estimate the battery life of a battery. These additional physical parameters may include the battery's usable capacity, charge and discharge rates, age, life cycle, or chemical composition, the physical layout of the circuitry coupled to the battery, the ambient temperature, hysteresis profile, or other parameters pertinent to estimating the battery life of a battery. Finally, more than one type of battery sensor may be employed in each earpiece, and each battery sensor may employ other known methods (e.g. impedance spectroscopy, specific gravity) to estimate the battery life of a battery.

First transceiver 20 is operably coupled to the first earpiece housing 12 and second transceiver 34 is operably coupled to the second earpiece housing 26 and each transceiver is configured to receive signals from the peripheral device 65 for additional power and to transmit signals requesting additional information to the peripheral device 65 if necessary. For example, if a signal transmitted by the peripheral device 65 does not contain an exact amount of additional power to provide, the first transceiver 20 may be instructed by first processor 24 and/or the second transceiver 34 may be instructed by second processor 38 to transmit a return signal encoding a request for additional power to provide. In addition, first transceiver 20 and second transceiver 34 may be configured to transmit signals encoding data, information, and/or applications related to a task to the other earpiece if the task cannot be performed due to insufficient battery life or transferring the task would allow an earpiece to better provide additional power to the peripheral device 65.

The determination of whether transferring a task would better allow an earpiece to provide additional power to the peripheral device 65 may be performed by either the first processor 24 or the second processor 38. For example, if the second processor 38 receives a signal encoding the battery life of the first earpiece 11, and in light of the information determines transferring a portion or all of a sensor analysis task it is currently performing would better permit the second earpiece 25 to provide additional power to the peripheral device 65 (assuming the peripheral task transmitted a request for additional power), the second processor 38 may instruct the second transceiver 34 to transmit a signal encoding data, information, or one or more programs, applications, or algorithms related to the sensor analysis task to the first transceiver 20 of the first earpiece 11. The first transceiver 20 may then retransmit the signal to the first processor 24, which may pick up the sensor analysis task being performed by the second earpiece 25 using the data, information, or programs, applications, or algorithms encoded in the signal from the second earpiece 25. The first transceiver 20 and the second transceiver 34 may be near field magnetic induction (NFMI) transceivers.

The transceivers 20 and/or 34 are components comprising both a transmitter and receiver which may be combined and share common circuitry on a single housing. The transceivers 20 and 34 may communicate utilizing Bluetooth, Wi-Fi, ZigBee, ANT+, near field communications, wireless USB, infrared, mobile body area networks, ultra-wideband communications, cellular or other suitable radio frequency standards, networks, protocols or communications. The transceivers 20 and 34 may also be a hybrid transceiver supporting many different communications. For example, the transceivers 20 and 34 may communicate with the wireless earpieces 11 and/or 25 utilizing NFC or various Bluetooth communications. Transceivers 20 and/or 34 could also utilize a virtual sim card to perform telecommunications with a mobile phone, peripheral device 65 and/or a network.

First battery 22 is operably coupled to all the components of the first earpiece 11 and second battery 36 is operably coupled to all the components of the second earpiece 25 and each battery may provide enough power to operate each earpiece for a reasonable duration of time. The first battery 22 and the second battery 36 may be of any type suitable for powering the first earpiece 11 and the second earpiece 25, including alkaline batteries or lithium ion batteries. Alternatively, battery-less power sources, such as sensors configured to receive energy from radio waves (all of which are operably coupled to one or more of the earpieces) may be used to power the earpieces in lieu of either battery. In other embodiments, the batteries 22 and/or 36 may represent a fuel cell, thermal electric generator, piezo electric charger, solar charger, ultra-capacitor, or other existing or developing power storage technologies.

First processor 24 is operably coupled to each component of the first earpiece 11 and second processor 38 is operably coupled to each component of the second earpiece 25. Each processor is configured to transfer one or more tasks to the other earpiece if either of the processors determines the task they are currently performing or scheduled to perform either (1) cannot be performed due to insufficient battery life, (2) would maximize the useful battery life of the set of wireless earpieces 10 and/or the peripheral device 65 to transfer either a portion or all of the task to the other earpiece or data allowing the other earpiece to perform the task, or (3) would allow one of the earpieces to provide additional power to peripheral device 65.

The first processor 24 or the second processor 38 may transfer tasks to one another by executing a program, application, or algorithm stored in a memory to transfer either (1) instructions for carrying out the tasks, (2) one or more programs, applications, or algorithms for carrying out the tasks, such as the methods for managing battery life of a peripheral device battery 100, 200 and/or 300, and/or (3) data for use in carrying out the tasks.

The tasks may be carried out by first processor 24 or second processor 38 may include background processing tasks, audio processing tasks, sensor data analysis tasks, fitness related tasks, or other computational related tasks. For example, the first processor 24 may determine from prior user preferences stored in a memory a program for measuring jogging distance is likely to use all of the battery life of the first battery 22, and instruct the first transceiver 20 to transmit one or more signals to the second transceiver 34 of the second earpiece 25 encoding (1) instructions to commence the jogging program, (2) instructions to commence the jogging program at the specific point the first processor 24 instructed the first transceiver 20 to transmit the signal to transfer the jogging program task, (3) data of the jogging measurements to be used in the jogging program, and/or (4) one or more programs, applications, or algorithms used to measure jogging distance if the second earpiece 25 lacks such a program.

Each processor 24 and/or 38 may run other programs in addition to programs for measuring battery life, determining whether to transfer a task to the other earpiece, or transferring additional power to the peripheral device 65. In addition, first processor 24 may instruct the first battery 22 or the second processor 38 may instruct the second battery 36 to transfer a portion of the charge (power) carried on the battery to the peripheral device 65 in response to a signal encoding the request from the peripheral device 65. The power may be transferred either via a first interface 66 on the first earpiece 11 or a second interface 68 on the second earpiece 25 through the user's ear to an interface 70 on the peripheral device 65. The current should be in the milliamp range to avoid injury to the user. Alternatively, power may also be transferred via magnetic induction to the peripheral device 65.

The processors 24 and/or 38 are the logic controlling the operation and functionality of the earpieces 11 and/or 25. The processors 24 and/or 38 may include circuitry, chips, and other digital logic. The processors 24 and/or 38 may also include programs, scripts, and instructions implemented to operate the processors 24 and/or 38. The processors 24 and/or 38 may represent hardware, software, firmware or any combination thereof. In one embodiment, the processors 24 and/or 38 may include one or more processors, such as microprocessors. The processors 24 and/or 38 may also represent an application specific integrated circuit (ASIC) or field programmable gate array (FPGA).

For example, a processor included in the processors 24 and/or 38 are circuitry or logic enabled to control execution of a set of instructions. The processors 24 and/or 38 may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processors 24 and/or 38 may also manage transmission and reception of audio and data, GPS information, wireless LAN, GSM, or LTE, SIM or data cards, or so forth. The processors 24 and/or 38 may be a single chip or integrated with other computing or communications elements of the earpieces 11 and/or 25.

The peripheral device 65 is worn by the user and may electronically interact with one or more of the first earpiece 11 or the second earpiece 25 of the set of wireless earpieces 10. The peripheral device 65 may be an electronic eyepiece wearable by a user (e.g. Google Glass, Snapchat Spectacles), a virtual reality device (e.g. Oculus Rift, PlayStation VR, HTC Vive), a digital recording device, or another type of electronic wearable device. In some preferred embodiments the peripheral device 65 is worn at a location on the user's head and may be operably coupled with one or more of the earpieces 11 and/or 25 of the set of wireless earpieces 10.

The peripheral device 65 includes at least one peripheral interface 70 to receive power from one or more earpieces 11 and/or 25 of the set of wireless earpieces 10. Power may be received continuously or intermittently depending on the requirements of the peripheral device 65 and/or the requirements of the set of wireless earpieces 10. A peripheral device transceiver 71 is operably coupled to the peripheral device 65 and is configured to transmit signals encoding requests for additional power from the first earpiece 11 or the second earpiece 25 in response to a command from the peripheral device processor 72. The peripheral device transceiver 71 may also be configured to receive signals from the first earpiece 11 or the second earpiece 25 concerning requests for additional power. The peripheral device processor 72 is disposed within the peripheral device 65 and is configured to instruct the peripheral device transceiver 71 to transmit one or more signals encoding a request for additional power from the first earpiece 11 and/or the second earpiece 25. A peripheral device battery 73 is operably coupled to each component of the peripheral device 65 and may power each component of the peripheral device 65. The peripheral device battery 73 may also receive power from one or more earpieces (first earpiece 11 or second earpiece 25) if the peripheral device processor 72 instructs the peripheral device transceiver 71 to transmit a signal encoding a request for additional power.

First interface 68 is operably coupled to the first earpiece housing 12 and the first battery 22 and second interface 69 is operably coupled to the second earpiece housing 26 and the second battery 36 and each interface is configured to allow the transfer of power to the peripheral device 65. The interface includes a sufficient surface area to contact the skin of the user's ear to allow for the provision of power from one or both batteries 22 and/or 36 to the peripheral device 65. In some preferred embodiments the peripheral interfaces 70 of the peripheral device 65 are placed at a location where the path of the transfer of power from each earpiece is minimized to reduce power loss. The power transferred from each earpiece 11 and/or 25 may be transferred galvanically to the peripheral interfaces 70 of the peripheral device 65. The power may be transferred continuously, intermittently or in accordance with one or more programs or applications of one or more of the earpieces.

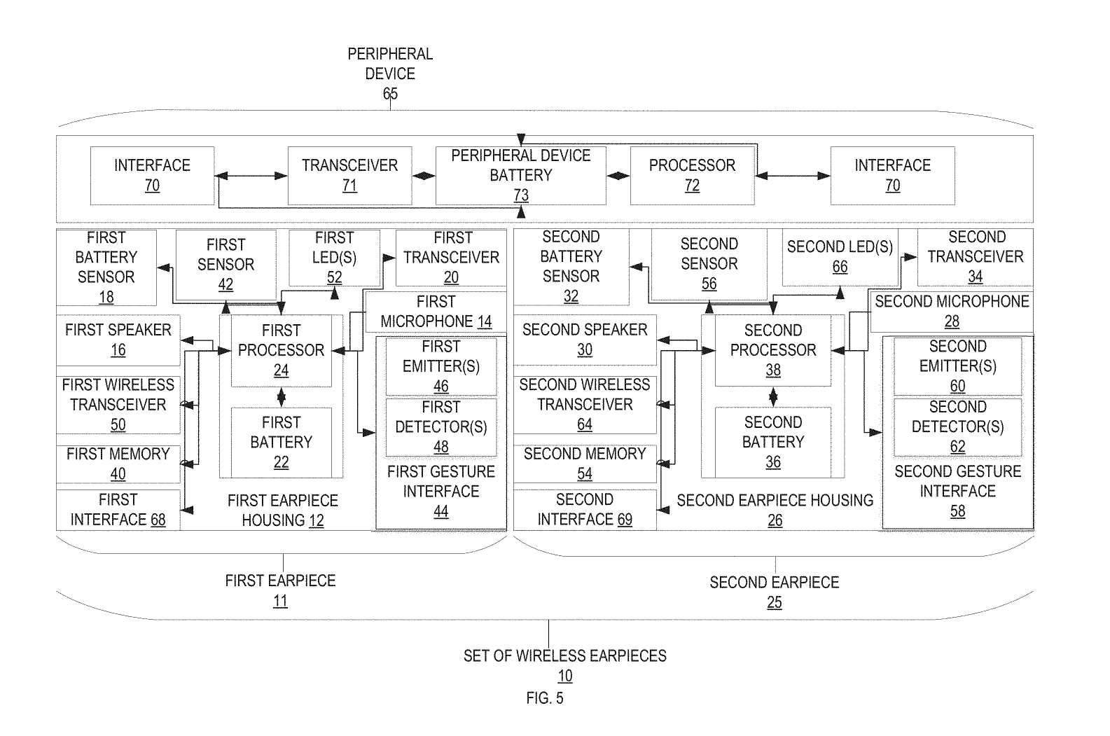

FIG. 5 illustrates a second embodiment of the set of wireless earpieces 10. In addition to the elements described in FIG. 4 above, the first earpiece 11 and the second earpiece 25 of the set of wireless earpieces 10 may each include a memory, one or more sensors, a wireless transceiver, a gesture interface, or one or more LEDs.

First memory 40 may be operably coupled to the first earpiece housing 12, first battery 22, and first processor 24 and second memory 54 may be operably coupled to second earpiece housing 26, second battery 36, and second processor 38. Each memory may have one or more programs, applications, or algorithms related to (1) determining the battery life of a battery, such as managing battery life of a peripheral device battery programs 100, 200 and/or 300, (2) transferring a task to the other earpiece, (3) background tasks, audio processing tasks, sensor data analysis tasks and/or fitness tasks desired by the user or required by the earpiece, and/or (4) other tasks required by one of the earpieces. In addition, each memory may have one or more programs, applications, or algorithms used to transfer power to the peripheral device 65. Each memory may also contain files received from an external electronic device such as songs or other related media as well.

The memories 40 and/or 54 are a hardware element, device, or recording media configured to store data for subsequent retrieval or access later. The memories 40 and/or 54 may be static or dynamic memory. The memories 40 and/or 54 may include a hard disk, random access memory, SSD, quantum computing drive, cache, removable media drive, mass storage, or configuration suitable as storage for data, instructions, and information. In one embodiment, the memories 40 and 54 and the processors 24 and/or 38 may be integrated. The memories 40 and/or 54 may use any type of volatile or non-volatile storage techniques and mediums. The memories may store information related to the status of the earpieces 11 and/or 25 as well as the peripheral device 65.

First sensor 42 may be operably coupled to the first earpiece housing 12, first battery 22, and first processor 24 and second sensor 56 may be operably coupled to second earpiece housing 26, second battery 36, and second processor 38. Each sensor may be configured to sense one or more physiological or environmental parameters for use by the earpieces. For example, first sensor 42 may be a pulse oximeter and be configured to measure the heart rate and blood oxygen levels of the user, and second sensor 56 may be a thermometer and configured to measure air pressure in addition to the current temperature. The sensor readings from the sensors may be used by one or more programs or applications executed by a processor to perform one or more tasks. Sensor readings may also be stored in the first memory 40 or second memory 54 for future use.

The housings 12 and/or 26 may include sensors 42 and/or 56 for sensing pulse, blood oxygenation, temperature, voice characteristics, skin conduction, glucose levels, impacts, activity level, position, location, orientation as well as any number of internal or external user biometrics. In other embodiments, the sensors 42 and/or 56 may be positioned to contact or be proximate the epithelium of the external auditory canal or auricular region of the user's ears when worn. For example, the sensors 42 and/or 56 may represent various metallic sensor contacts, optical interfaces or even micro-delivery systems for receiving, measuring and delivering information and signals. Small electrical charges or spectroscopy emissions (e.g., various light wavelengths) may be utilized by the sensors 42 and/or 56 to analyze the biometrics of the user including pulse, blood pressure, skin conductivity, blood analysis, sweat levels and so forth. In one embodiment, the sensors 42 and/or 56 may include optical sensors emitting and measuring reflected light within the ears of the user to measure any number of biometrics. The optical sensors may also be utilized as a second set of sensors to determine when the earpieces 11 and/or 25 are in use, stored, charging, or otherwise positioned. The sensors 42 and/or 56 may include an array of components.

The sensors 42 and/or 56 may be utilized to provide relevant information communicated through the transceivers 50 and/or 64. As described, the sensors 42 and/or 56 may include one or more microphones 14 and/or 28 integrated with the housings 12 and/or 26. For example, an external microphone 14 and/or 28 may sense environmental noises as well as the user's voice as communicated through the air of the communications environment. The external microphones 14 and/or 28 may sense additional user's voices to perform recordings, analysis, actions, or otherwise facilitate the activities of the user. An ear-bone or internal microphone may sense vibrations or sound waves communicated through the head of the user (e.g., bone conduction, etc.).

First gesture interface 44 may be operably coupled to the first earpiece housing 12, first battery 22 and first processor 24 and second gesture interface 58 may be operably coupled to second earpiece housing 26, second battery 36, and second processor 38. First gesture interface 44 may be configured to allow the user to control one or more functions of the first earpiece 11 and the second gesture interface 58 may be configured to allow the user to control one or more functions of second earpiece 25. First gesture interface 44 may include one or more emitters 46 and one or more detectors 48 and second gesture interface 58 may include one or more emitters 60 and one or more detectors 62, wherein the emitters and the detectors may be used to detect gestures from either the user, a third party, an instrument, or a combination of the aforementioned and communicate one or more signals representing the gesture to the first processor 24 or the second processor 38. The gestures may be used with the gesture interfaces to control an earpiece 11 and/or 25 including, without limitation, touching, tapping, swiping, use of an instrument, or any combination of the gestures. Touching gestures used to control an earpiece may be of any duration and may include the touching of areas are not part of a gesture interface. Tapping gestures used to control an earpiece may include any number of taps and need not be brief. Swiping gestures used to control an earpiece may include a single swipe, a swipe changes direction at least once, a swipe with a time delay, a plurality of swipes, or any combination of the aforementioned. An instrument used to control an earpiece may be electronic, biochemical or mechanical, and may interface with a gesture interface either physically or electromagnetically.

First wireless transceiver 50 may be operably coupled to the first earpiece housing 12, first battery 22, and first processor 24 and second wireless transceiver 64 may be operably coupled to second earpiece housing 26, second battery 36, and second processor 38. Each wireless transceiver may be configured to receive one or more signals from and/or transmit one or more signals to an external electronic device. The signals received by a wireless transceiver may be stored in a memory or processed by the processor before being stored in the memory. The external electronic devices the wireless transceivers may be configured to receive signals from include Bluetooth devices, mobile devices, desktops, laptops, tablets, modems, routers, communications towers, cameras, watches, third-party earpieces, earpieces, or other electronic devices capable of transmitting or receiving wireless signals. Each wireless transceiver may receive signals encoding programs, applications, or algorithms to be used in transferring tasks between the earpieces or transferring power to the peripheral device 65. Each wireless transceiver may receive or transmit more than one signal simultaneously.

First LEDs 52 may be operably coupled to the first earpiece housing 12, first battery 22, and first processor 24 and second LEDs 66 may be operably coupled to second earpiece housing 26, second battery 36, and second processor 38. First LEDs 52 and second LEDs 66 may be configured to provide information concerning the battery life of the first earpiece 11 and the second earpiece 25, respectively. For example, first processor 24 may communicate a signal encoding the status of the battery level of the first battery 22 to the first LEDs 52, wherein the signal encoding the battery level of the first battery 22 may be decoded by the first LEDs 52 as a blinking light, wherein a green light may represent a substantial level of battery life, a yellow light may represent an intermediate level of battery life, and a red light may represent a limited amount of battery life, a blinking red light may represent a critical level of battery life requiring immediate recharging.

The second LEDs 66 may perform similar functions on signals communicated by the second processor 38 of the second earpiece 25. In addition, the battery life may be represented by the LEDs as a percentage of battery life remaining or may be represented by an energy bar having one or more LEDs, wherein the number of illuminated LEDs represents the amount of battery life remaining in the earpiece. In addition, the LEDs may decode signals received from the processors related to the current time, the status of one or more operations of an earpiece, or another earpiece function and display the information encoded in the signals. Each of the LEDs may be in any area on an earpiece suitable for viewing by the user or a third party and may also consist of as few as one diode which may be provided in combination with a light guide. In addition, the LEDs need not have a minimum luminescence.

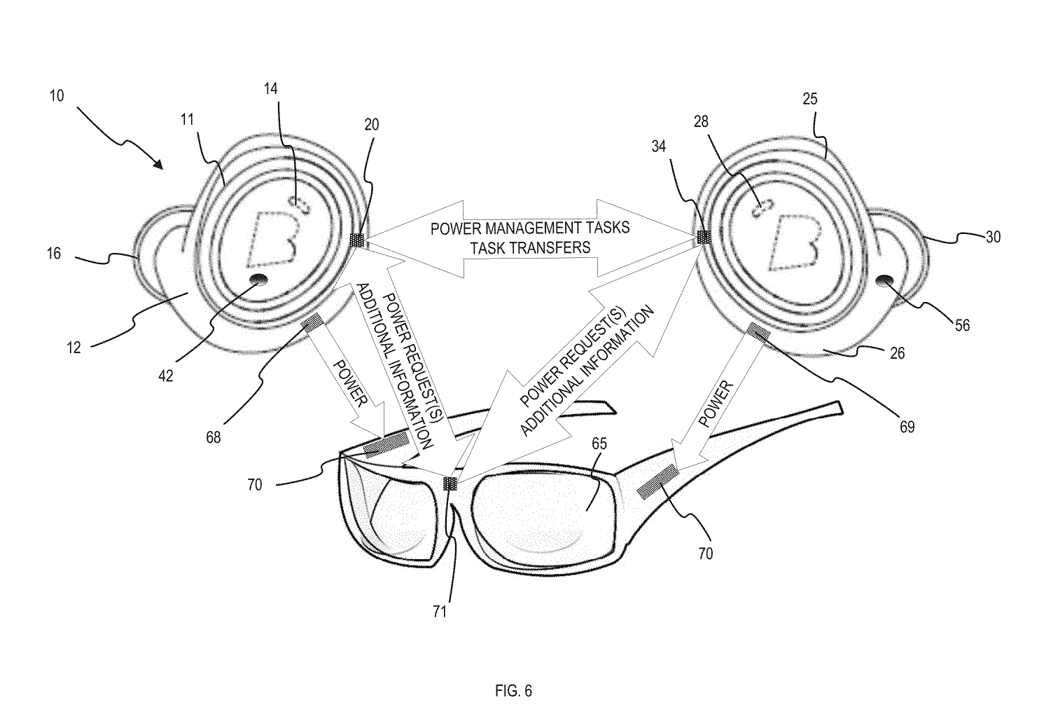

FIG. 6 illustrates the set of wireless earpieces 10 which includes the first earpiece 11, the second earpiece 25, and the peripheral device 65. The first earpiece 11 includes the first earpiece housing 12. The second earpiece 25 includes the second earpiece housing 26. The first earpiece 11 and the second earpiece 25 may each be configured to fit on, at, or within a user's external auditory canal and may be configured to substantially minimize or eliminate external sound capable of reaching the tympanic membrane. The first earpiece housing 12 and the second earpiece housing 26 may be configured to be soundproof or waterproof. First microphone 14 is shown on first earpiece 11 and second microphone 28 is shown on second earpiece 25 and each microphone may be configured or positioned to receive voice commands as necessary. First transceiver 20 and second transceiver 34 are also shown. Each of the transceivers may be NFMI transceivers and may be configured to transmit signals to or receive signals from the other earpiece concerning the provision of additional power to a peripheral device. The signals may be transmitted or received through the user's head.

In addition, the transceivers may transmit or receive signals encoding data, information, or applications related to one or more tasks performed on the other earpiece to maximize the ability to provide additional power to the peripheral device 65. First speaker 16 and second speaker 30 are also shown and may be configured to communicate tasks being performed on their respective earpieces or tasks transmitted from the other earpiece. For example, if the second speaker 30 was communicating information related to a workout task and the second processor 38 determined the battery life of second battery 36 was insufficient to complete the workout task, the second processor 38 may instruct the second transceiver 34 to transmit a signal encoding data, information, or algorithms related to the workout task to the first processor 24 via the first transceiver 20, wherein the first processor 24 may subsequently take over a portion of the workout task, such as performing an analysis of certain physiological measurements while the second speaker 30 of the second earpiece 25 continued to communicate information related to the workout task. The first speaker 16 may communicate a portion of the workout task now being performed by the first earpiece 11. In addition, each of the speakers may short out if the decibel level reaches a critical threshold. First sensor 42 and second sensor 56 are shown. Each of the sensors may be located anywhere on the earpiece conducive to acquiring sensor readings and the sensor readings may be encoded in signals transmitted or received by one of the transceivers of the set of wireless earpieces 10.

The peripheral device 65 is shown. The peripheral device 65 may include a plurality of peripheral interfaces 70 for receiving additional power from interfaces 68, 69 operably coupled to the set of wireless earpieces 10. The additional power may be transferred galvanically through the skin of the user's ear to the peripheral interfaces 70 of the peripheral device 65. The peripheral device 65 may receive power continuously, intermittently or periodically according to a specific schedule determined by either one or more of the earpieces or the peripheral device 65. A peripheral device transceiver 71 is shown on the peripheral device 65. The peripheral device transceiver 71 may transmit signal encoding requests for additional power to the first earpiece 11 or the second earpiece 25 and receive signals for additional information if required. The power delivered to the peripheral device 65 may be discontinued if the peripheral device battery 73 receives sufficient charge (power), one or more of the earpieces lacks the charge to supply the peripheral device 65 with additional power, or the peripheral device 65 transmits a signal encoding a cessation request to each earpiece supplying power to cease transmission of additional power.

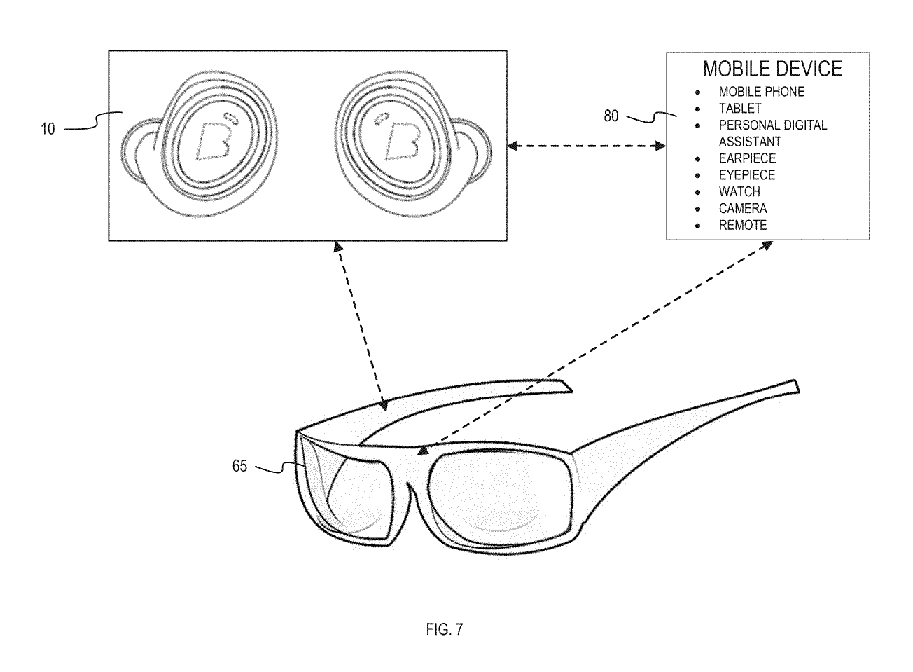

FIG. 7 illustrates the set of wireless earpieces 10, the peripheral device 65, and their relationship to a mobile device 80. The mobile device 80 may be a mobile phone, a tablet, a watch, a PDA, a remote, an eyepiece, an earpiece or any electronic device not requiring a fixed location. The user may use a software application on the mobile device 80 to instruct an earpiece to provide additional power to the peripheral device 65. For example, the user may use a software application on the mobile device 80 to access a screen providing one or more options related to transferring additional power from either a left earpiece, a right earpiece, or both earpieces to the peripheral device 65. Additionally, the user may also use the software application to transfer power from the peripheral device to one or more of the earpieces. Selections may be communicated via a transceiver in the mobile device 80 to one or more of the earpieces of the set of wireless earpieces 10 or the peripheral device 65. The same application may provide a visual indicator showing the amount of power has been transferred and the amount of time the transfer is likely to take. In addition, the same application or another application may be used by the user to transfer one or more computing tasks between the set of wireless earpieces 10 and the peripheral device 65, which may be employed if it is determined a reassignment of one or more tasks would better maximize the time the set of wireless earpieces 10 and the peripheral device 65 could be used together before one of the devices requires recharging.

Although various apparatus, methods, and systems have been shown and described, it is to be understood the present invention contemplates numerous options, variations, and alternatives. The invention is not to be limited to the embodiments described herein. The foregoing description has been presented for purposes of illustration and description. It is not intended to be an exhaustive list or limit any of the invention to the precise forms disclosed. It is contemplated other alternatives or exemplary aspects are considered included in the invention. The description is merely examples of embodiments, processes or methods of the invention. It is understood any other modifications, substitutions, and/or additions can be made, which are within the intended spirit and scope of the invention.

What is claimed is:

1. A method of managing battery life for a peripheral device battery comprising:
monitoring the battery life of the battery using a battery sensor operably coupled to the peripheral device;
communicating a signal to an earpiece worn by a user if the battery life of the battery falls below a critical threshold, wherein the signal encodes a request to provide additional power to the peripheral device; and
receiving the additional power from the earpiece worn by the user.

2. The method of claim 1 wherein the peripheral device is an eyepiece.

3. The method of claim 1 wherein the peripheral device is a virtual reality device.

4. The method of claim 1 wherein the peripheral device is a digital recording device.

5. The method of claim 1 wherein the signal further encodes an amount of power to provide to the peripheral device.

6. The method of claim 1 wherein the additional power is received galvanically from the user.

7. A method of providing battery life to a battery of a peripheral device using an earpiece worn by a user comprising:
receiving a first signal from the peripheral device, wherein the signal encodes a request for additional power; and
providing the additional power to the peripheral device in response to the first signal.

8. The method of claim 7 wherein the peripheral device is an eyepiece, a virtual reality device, or a digital recording device.

9. The method of claim 7 wherein the additional power is provided galvanically through a user.

10. The method of claim 7 wherein the reception of the first signal from the peripheral device is at a transceiver of a left earpiece.

11. The method of claim 7 wherein the reception of the first signal from the peripheral device is at a transceiver of a right earpiece.

12. The method of claim 7 further comprising transmitting a second signal to the peripheral device in response to the first signal, wherein the second signal encodes a request for an additional amount of power to provide.

13. The method of claim 12 further comprising receiving a third signal from the peripheral device in response to the second signal, wherein the third signal encodes the amount of additional power to provide.

14. The method of claim 7 wherein the provision of the additional power is provided continuously.

15. The method of claim 14 further comprising receiving a signal from the peripheral device encoding a power termination request.

16. A system comprising:
a set of earpieces, wherein each earpiece further comprises an earpiece housing, a transceiver disposed within the earpiece housing, a processor disposed within the earpiece housing and operably coupled to the transceiver, a battery disposed within the earpiece housing and operably coupled to the transceiver and the processor, and an interface operably coupled to the earpiece housing and the battery; and
a peripheral device operably coupled to the set of earpieces, the peripheral device comprising at least one peripheral interface, a peripheral device transceiver disposed within the peripheral device, a peripheral device processor operably coupled to each peripheral interface and the peripheral transceiver, and a peripheral device battery operably coupled to each peripheral interface, the peripheral device transceiver, and the peripheral device processor;
wherein each earpiece of the set of earpieces is configured to provide additional power to the peripheral device via the interfaces in response to a signal from the peripheral device encoding a request for the additional power.

17. The system of claim 16 wherein the peripheral device is an eyepiece, a virtual reality device, or a digital recording device.

18. The system of claim 16 wherein each interface of the set of wireless earpieces and each peripheral interface of the peripheral device is positioned along a surface of a user's ear.

19. The system of claim 18 wherein the additional power is provided to the peripheral device battery via at least one interface of the set of wireless earpieces and at least one peripheral interface of the peripheral device.

20. The system of claim 19 wherein the signal encodes an amount of additional power to provide to the peripheral device battery.
